(19) United States
(12) Patent Application Publication
(10) Pub. No.: US 2007/0137365 A1
(43) Pub. Date: Jun. 21, 2007

(54) Desk type clip driver

(76) Inventor: Yong-woo Lee, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/298,055

(22) Filed: Dec. 9, 2005

(30) Foreign Application Priority Data
Sep. 26, 2005 (KR) 2005-89190

(51) Int. Cl. G05G 5/00

(52) U.S. Cl. 74/473.21

(57) ABSTRACT

The present invention discloses a desk type clip driver. The desk type clip driver comprises first and second connecting members in which an end of each is rotatably combined with each other and the combined portion is rotatably combined with a portion of the handle member; a sliding member in which its upper portion is rotatably combined with the other end of the first connecting member so that it is moved forwardly, backwardly and horizontally toward the clip opening springs of the driver body; an elastic member in which an end thereof is fixed to an end of the sliding member and the other end there is fixed to the inside of the driver body; and a sliding stop member rotatably mounted to the inside of the driver body by interposing a twisted spring and having a hooking member, the hooking member which is extended and formed from the center of the sliding stop member and is contacted with the bottom of the sliding member so that the sliding member is temporarily stopped.

### TECHNICAL FIELD

The present invention relates to a desk type clip driver, and in particular to a desk type clip driver in which in a state that a plurality of clips are waiting continuously, when using the clip driver, a clip is loaded exactly one by one, thereby a clip loading process is performed smoothly and exactly. The desk type clip driver includes a driving apparatus for transferring the clip to the inside of a casing and then fastening the document by the clip. The driving apparatus comprises a handle member, a connection member and a sliding member, so that when the operation of the handle member is started, the sliding member is moved through the connection member and then the clip is pushed, thereby a user fastens the document by the clip.

### BACKGROUND ART

In a conventional desk type driver, a plurality of clips are loaded to the inside thereof and the loaded clips are pushed by means of a driving apparatus and then the clips are spread, thereby capable of fastening the document.

In general, in a shape of the clip for fastening the documents and the like, the side cross section of the clip is similarly a shape of ‘ [symbol] ’. Accordingly, in the conventional clip driver, there is a disadvantage that when the clips are loaded to the inside of the clip driver and used, the clips are superposed or jammed in each other, so that the function for fastening the document by means of the clip is impossible or deteriorated.

In addition, in the conventional clip driver, there is another disadvantage that the structure of the driving member for pushing the clips loaded to the inside of the clip driver is very inconvenient to use because of requiring for much strength.

### SUMMARY OF THE INVENTION

Accordingly, it is a primary object of the present invention to provide a desk type clip driver in which when fastening the document, one clip is exactly loaded one by one to the inside of the desk type clip driver.

Another object of the present invention is to provide a desk type clip driver in which the structure for pushing the clip is improved, thereby easily capable of pushing the clip with a little strength and of fastening the document and the like.

### DETAILED DESCRIPTION OF THE INVENTION

In order to achieve the first object of the invention, there is provided a desk type clip driver: in a desk type clip driver in which a clip having a pair of plane type fastening portions for fastening document, which are contacted elastically with each other, a driver body in which a paper inserting portion for inserting the document and a pair of clip opening springs having opposite guiding faces, gradually spread, are formed at the front portion thereof, a handle member which is rotatably mounted to the inside of the driver body and has guide paths for guiding the clips toward the clip opening springs, whereby the clips are loaded continuously and slidably to the guide paths and advanced along the guide paths and the clip is spread so that the document is fastened, the desk type clip driver comprises: first and second connecting members in which an end of each is rotatably combined with each other and the combined portion is rotatably combined with a portion of the handle member; a sliding member in which its upper portion is rotatably combined with the other end of the first connecting member so that it is moved forwardly, backwardly and horizontally toward the clip opening members of the driver body; an elastic member in which an end thereof is fixed to an end of the sliding member and the other end there is fixed to the inside of the driver body; and a sliding stop member rotatably mounted to the inside of the driver body by interposing a twisted spring and having a hooking member, the hooking member which is extended and formed from the center of the sliding stop member and is contacted with the bottom of the sliding member so that the sliding member is temporarily stopped.

Preferably, the driver body includes guiding members for stably loading the clips in which they are formed upwardly from the inside thereof so that they are coincided with the guide paths, and the guiding members are oppositely formed to the inside surface of the driver body.

More preferably, the handle member includes guide paths for guiding clips in which they are longitudinally formed to the inside thereof with a direct line shape, a pair of hinge combining members in which they are formed at an end thereof, and a pair of guide members having a guide oblong hole with a curved line shape in which they are formed at both side surfaces thereof, and the transversely cross section of the handle member has a stepwise shape.

More preferably, the first and second connecting members and the handle member are combined with each other by a fixing shaft which is penetrated through the hole of the ring shape connecting member and the holes of hinge combining members and the guide oblong hole, and rollers ratably positioned between the hinge combining members of the handle member and the hinge combining members of the second connecting member, when operating the handle member, the upper outer surfaces of the rollers are contacted with the ‘ [symbol] ’ shape inside surface of the handle member.

More preferably, the sliding member includes a sliding groove which is formed at the bottom thereof, a partition member 36 which is formed at the center portion of the sliding groove, one or more saw teeth which are formed at a portion of the sliding groove partitioned by the partition member, an extension portion having an arc portion which is formed at the end portion of the saw teeth, the arc portion contacted with an arc portion of a guide member, and an inclined portion which is gradually and upwardly protruded from the bottom surface of the other portion of the groove partitioned by the partition member.

### BRIEF DESCRIPTION OF THE DRAWINGS

The present invention will become better understood with reference to the accompanying drawings which are given only by way of illustration and thus are not limitative of the present invention, wherein:

FIG. 1 is an exploded perspective view illustrating a desk type clip driver in accordance with the present invention;

FIG. 2 is a perspective view illustrating a desk type clip driver in accordance with the present invention;

FIG. 3 is a perspective view illustrating a clip used in a desk type clip driver in accordance with the present invention;

FIG. 4 is a bottom perspective view illustrating concretely a sliding means of FIG. 1;

FIG. 5 is a side cross sectional view illustrating a desk type clip driver of FIG. 1;

FIG. 6 is a view illustrating an operating state of FIG. 1 which is similar to FIG. 5; and

FIG. 7 is a cross sectional view with line A-A of FIG. 5.

### DETAILED DESCRIPTION OF THE PREFERRED EMBODIMENTS

A desk type clip driver in accordance with preferred embodiments of the present invention will now be described in detail with reference to the accompanying drawings.

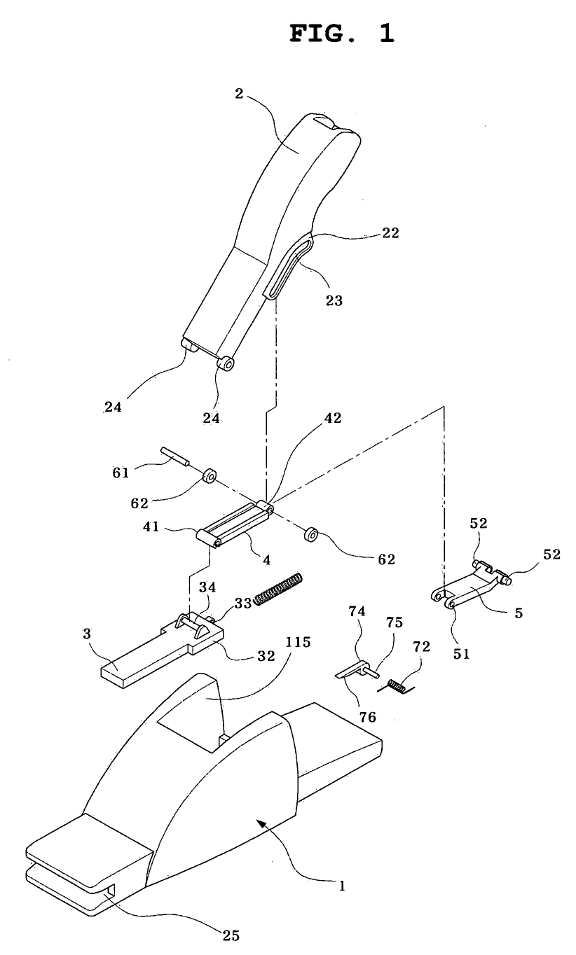

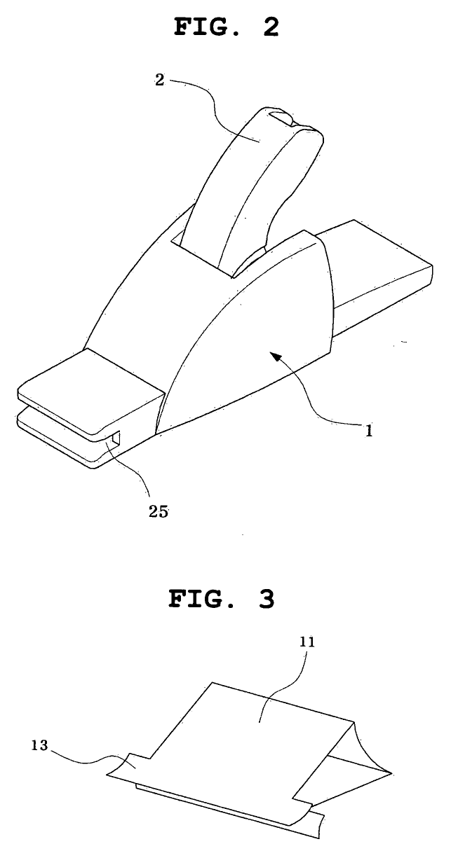

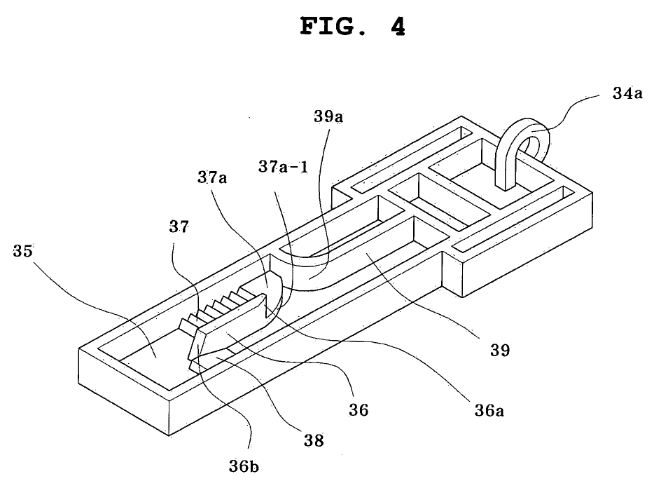

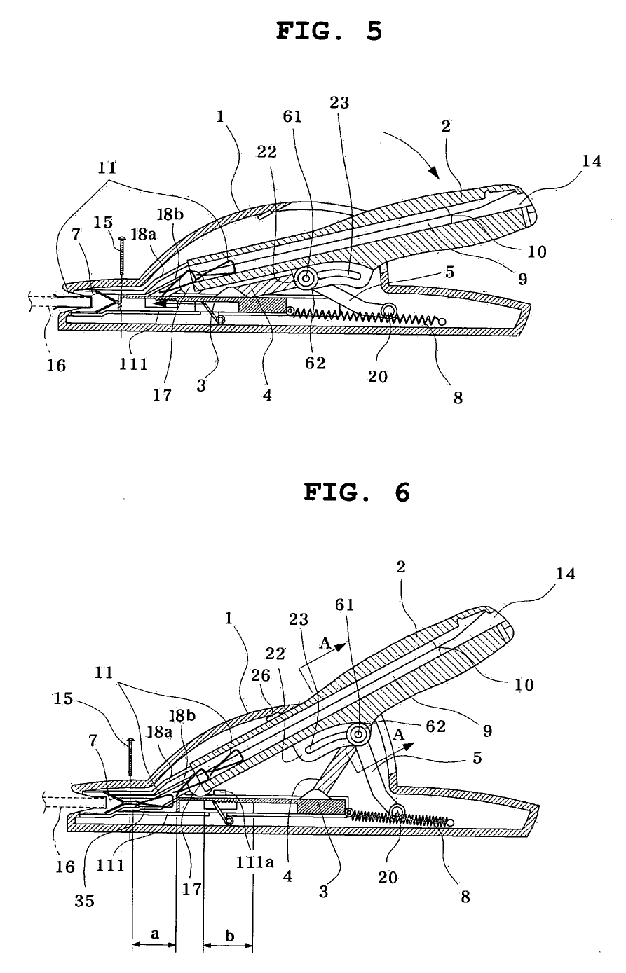

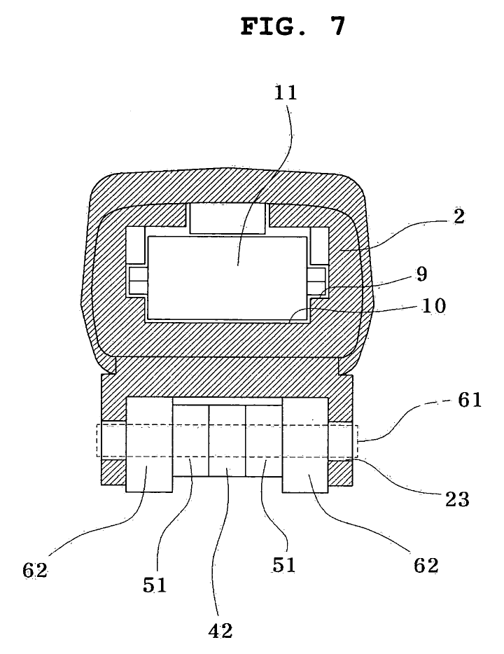

FIG. 1 is an exploded perspective view illustrating a desk type clip driver in accordance with the present invention, FIG. 2 is a perspective view illustrating a desk type clip driver in accordance with the present invention, FIG. 3 is a perspective view illustrating a clip used in a desk type clip driver in accordance with the present invention, FIG. 4 is a bottom perspective view illustrating concretely a sliding means of FIG. 1, FIG. 5 is a side cross sectional view illustrating a desk type clip driver of FIG. 1, FIG. 6 is a view illustrating an operating state of FIG. 1 which is similar to FIG. 5, and FIG. 7 is a cross sectional view with line A-A of FIG. 5.

Referring to FIGS. 1 to 7, the desk type clip driver in accordance with the present invention comprises a driver body 1, a handle member 2, a sliding member 3, first and second connecting members 4 and 5 and a sliding stop member

A paper inserting portion 25 is formed at the front part of the driver body 1 and a pair of clip opening members are fixed by a spring fixing pin(not shown) at the front part of the driver body 1. A reference numeral 115 denotes a handle member mounting portion.

In the handle member 2, guide paths 9 and 10 for guiding clips are longitudinally formed to the inside of the handle member with a direct line shape. A pair of hinge combining members 24 are formed at an end of the handle member and combined with a pair of hinge grooves 17 which are oppositely formed to the inside of the driver body 1(refers to FIG. 4). A pair of guide members 22 having a guide oblong hole 23 with a curved line shape are formed at both side surfaces of the handle member. The transversely cross section of the handle member 2 has a stepwise shape.

A reference numeral 4 denotes a first connecting member(may be called by a pushing rod). A ring type hinge guide member 41 is formed at an end of the first connecting member 4 and a ring type connecting member 42 is formed at the other end of the first connecting member 4. The bottom surface of the hinge guide member 41 is opened partly.

A reference number 5 denotes a second connecting member(may be called by a pressing rod). A pair of hinge combining members 51 for positioning coaxially to both side surfaces of the ring shape connecting member 42 of the first connecting member 4 are formed at an end of the second connecting member 5. A pair of hinge shafts 4 fixed transversely to the inside surfaces of the driver body 1 are formed at the other end of the second connecting member 5. The first and second connecting members and the handle member 2 are combined with each other by a fixing shaft 61 which is penetrated through the hole of the ring shape connecting member 42 and the holes of hinge combining members 51 and the guide oblong hole 23. A reference numeral 62 denotes a roller. The diameter of the roller 62 is larger than that of the ring shape connecting member 42. When operating the handle member 2, the upper outer surface of the roller 62 is contacted with the inside surface of the handle member 2(refers to FIG. 6). The rollers 62 are ratably positioned between the hinge combining members 24 of the handle member 2 and the hinge combining members 51 of the second connecting member 5.

A reference numeral 3 denotes a sliding member. The sliding member 3 having a predetermined length is slidably mounted to sliding member guiding members 111(refers to FIG. 4) which are formed in parallel to the bottom surface within the driver body 1. A hinge shaft 34 is formed transversely on a hinge mounting member 32 formed at the rear end of the sliding member 3, so that the hinge guide member 41 of the first connecting member 4 is mounted to the hinge shaft 34. A reference numeral 33 denotes a hooking member to which an end of a tension spring 8 which will be described hereinafter is fixed.

Referring to FIG. 4, in the sliding member 3, a sliding groove 35 is formed at the bottom thereof and a partition member 36 is formed at the center portion of the sliding groove 35. One or more saw teeth 37 are formed at a portion of the groove 35 partitioned by the partition member 36 and the extension portion 37a having an arc portion 37a-1 is formed at the end portion of the saw teeth 37. The arc portion 37a-1 is contacted with an arc portion 39a of a guide member 39. A reference numeral 38 denotes an inclined portion. The inclined portion 38 is gradually and upwardly protruded from the bottom surface of the other portion of the groove 35 partitioned by the partition member 36. The length of an end of the inclined portion 38 is extended slightly longer than that of an end of the partition member 36. A reference numeral 36a denotes an arc portion formed at an end of the partition member 36 and a reference numeral 36b denotes an inclined portion formed at the other end of the partition member 36.

In the driver body 1, guiding members 18a an 18b for stably guiding the clips 11 are formed upwardly from the inside of the driver body 1 so that they are coincided with the guide paths 9 and 10. The guiding members 18a and 18b are oppositely formed to the inside surface of the driver body 1. A reference numeral 111a denotes a stopper which is formed on the sliding member guiding member 111. The both sides of the sliding member 3 are guided and moved forwardly and backwardly by the sliding member guiding members 111.

The sliding stop member 74 comprises a rotating shaft 75 transversely protruded from its body and a rod shape hooking member 76 with a predetermined length extended from the body. The sliding stop member 74 is rotatably fixed to the inside of the driver body 1 through the rotating shaft 75. The rotating shaft 75 is surrounded by a twisted spring 72, so that the twisted spring 72 is interposed between the sliding stop member body and the inside surface of the driver body 1. An end of the twisted spring 72 is fixed to an end of the sliding stop member 74 and the other end of the twisted spring 72 is fixed to the bottom of the driver body 1.

An operation of the desk type clip driver according to the present invention will be described with reference to FIGS. 5 and 6.

FIG. 5 is a side cross sectional view illustrating a desk type clip driver of FIG. 1 and FIG. 6 is a view illustrating an operating state of FIG. 1 which is similar to FIG. 5.

Referring to FIGS. 5 and 6, the clip 11 is pushed to an inlet 14 of the handle member 2, starting from the wing 13 of the clip 11. The pushed clips 11 are loaded along guide paths 9 and 10 in the inside of the handle member 2. In an initial state, since the handle member 2 is inclined with a predetermined angle, the loaded clips 11 are downwardly moved. Thereafter, the wing 13 of the firstly loaded clip 11 among the loaded clips 11 is contacted with the rear portion of the clip opening member (V spring) 7 and the next clips 11 are loaded to the rear portion of the firstly loaded clip 11 sequentially.

When pressing downwardly the handle member 2, the roller 62 positioned at the second connecting member 5 is contacted and pushed to the inside arc portion of the guide member 22 of the handle member 2 and then transferred smoothly and forwardly. At this time, both ends of the fixing shaft 61 for fixing the handle member 2 and the second connecting member 5 are contacted with the inner circumference surfaces of the guide oblong holes 23 of the guide members 22. As a result, the handle member 2 is moved together with the second connecting member 5. In addition, the first connecting member 4 is also advanced and then since the hinge shaft 34 of the sliding member 3 is hinged with the hinge guide member 41 of the first connecting member 4, the sliding member 3 is also advanced horizontally, so that the rear portion of the clip 11 positioned to the clip opening member 7 is pushed by the front portion of the sliding member 3, thereby discharging the clip 11 to the outside.

When the clip 11 is discharged forwardly, the wing 13 of the clip 11 is spread by the clip opening member 7. Thereafter, the clip 11 is passed through the clip opening member 7, the document 16 are fastened by the wing 13 of the clip 11.

Like this, after fastening the document 16 through the clip 11 by pressing the handle member 2, the handle member 2 is returned to the original position by the tension spring 8 in which its both ends are hooked to a hooking ring 34a of the sliding member 3 and an inside ring of the driver body 1. That is, when the first connecting member 4 and the second connecting member 5 linked with the sliding member 3 are returned, the handle member 3 is pushed and then returned to the original position.

At this time, the clips loaded to the inside of the handle member 2 are moved downwardly one by one, because the handle member 2 is inclined, so that the foremost clip 11 is pushed and located to the rear end of the clip opening member 7.

In addition, when the sliding member 3 is advanced, the hooking member 76 of the sliding stop member 74 is contacted with the saw teeth 37 formed at the bottom of the sliding member 3 and then positioned and hooked by the trough of saw teeth 37. According this, the sliding member 3 can not be moved backwardly. When moving the sliding member 3, since the hooking member 76 is moved along the saw teeth 37 within the groove 35 and can not be escaped by the partition member 36.

Thereafter, when the sliding member 3 is continuously advanced, the hooking member 36 of the sliding stop member 74 is passed through the saw teeth 37 and the arc portion 37a-1 of the extension portion 37a and then moved to the bottom of the groove 35 of the sliding member 35, so that the hooking member 75 is contacted with the bottom of the groove on which saw teeth are not formed. Then the hooking member 76 is passed through the inclined portion 38 formed at the groove 35 and at this time, when the hooking member 76 is arrived at the end portion of the groove, the hooking member 76 is fallen at the bottom of the groove. Since there is no the partition member 36 at the end portion of the groove, thereafter, the hooking member 76 is returned to the original position(the saw teeth 37 of the groove 37) by the operation of the twist spring 72. Consequently, the sliding stop member 74 is contacted with the saw teeth 37 of the sliding member 3 according to the sliding member 3 and when the sliding stop member 74 is seceded from the saw teeth 37, the sliding stop member 74 is guided by the partition member 36 and returned to the original position. That is, the moving path of the sliding stop member 74 is a circle until the sliding stop member 74 returns to its original position.

As described above, according to the desk type clip driver according to the present invention, there is an advantage that since the clip is exactly and stably loaded to the rear of the clip opening member, a user can use the clip driver more conveniently compared to the conventional one.

Moreover, after the operation of the handle member, when the force applied to the handle member is removed, the handle member is returned to the original position by the operation of the spring, so that the user can use the clip driver more easily compared to the conventional one.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

What is claimed is:

1. In a desk type clip driver in which a clip having a pair of plane type fastening portions for fastening document, which are contacted elastically with each other, a driver body in which a paper inserting portion for inserting the document and a pair of clip opening springs having opposite guiding faces, gradually spread, are formed at the front portion thereof, a handle member which is rotatably mounted to the inside of the driver body and has guide paths for guiding the clips toward the clip opening springs, whereby the clips are loaded continuously and slidably to the guide paths and advanced along the guide paths and the clip is spread so that the document is fastened, the desk type clip driver comprising:
first and second connecting members in which an end of each is rotatably combined with each other and the combined portion is rotatably combined with a portion of the handle member;
a sliding member in which its upper portion is rotatably combined with the other end of the first connecting member so that it is moved forwardly, backwardly and horizontally toward the clip opening members of the driver body;
an elastic member in which an end thereof is fixed to an end of the sliding member and the other end there is fixed to the inside of the driver body; and
a sliding stop member rotatably mounted to the inside of the driver body by interposing a twisted spring and having a hooking member, the hooking member which is extended and formed from the center of the sliding stop member and is contacted with the bottom of the sliding member so that the sliding member is temporarily stopped.

2. The desk type clip driver according to claim 1, wherein the driver body includes guiding members for stably loading the clips in which they are formed upwardly from the inside thereof so that they are coincided with the guide paths, and the guiding members are oppositely formed to the inside surface of the driver body.

3. The desk type clip driver according to claim 1, wherein the handle member includes guide paths for guiding clips in which they are longitudinally formed to the inside thereof with a direct line shape, a pair of hinge combining members in which they are formed at an end thereof, and a pair of guide members having a guide oblong hole with a curved line shape in which they are formed at both side surfaces thereof, and the transversely cross section of the handle member has a stepwise shape.

4. The desk type clip driver according to claim 1, wherein the first and second connecting members and the handle member are combined with each other by a fixing shaft which is penetrated through the hole of the ring shape connecting member and the holes of hinge combining members and the guide oblong hole, and rollers ratably positioned between the hinge combining members of the handle member and the hinge combining members of the second connecting member, when operating the handle member, the upper outer surfaces of the rollers are contacted with the ‘ [symbol] ’ shape inside surface of the handle member.

5. The desk type clip driver according to claim 1, wherein the sliding member includes a sliding groove which is formed at the bottom thereof, a partition member 36 which is formed at the center portion of the sliding groove, one or more saw teeth which are formed at a portion of the sliding groove partitioned by the partition member, an extension portion having an arc portion which is formed at the end portion of the saw teeth, the arc portion contacted with an arc portion of a guide member, and an inclined portion which is gradually and upwardly protruded from the bottom surface of the other portion of the groove partitioned by the partition member.
